(19) United States
(12) Patent Application Publication
(10) Pub. No.: US 2015/0139417 A1
(43) Pub. Date: May 21, 2015

(54) SYSTEM AND METHOD FOR COMMUNICATION ROUTING

(71) Applicant: Interactive Intelligence, Inc., Indianapolis, IN (US)

(72) Inventors: Donald E. Brown, Indianapolis, IN (US); Jeroen Buis, Assendelft (NL); Michael D. Gagle, Lafayette, IN (US); Ronald T. Hynes, JR., Monrovia, IN (US); Jeffrey H. Swartz, Cary, NC (US)

(73) Assignee: Interactive Intelligence, Inc., Indianapolis, IN (US)

(21) Appl. No.: 14/082,844

(22) Filed: Nov. 18, 2013

(51) Int. Cl. H04M 3/523

(52) U.S. Cl. CPC H04M 3/5232
USPC 379/266.01

(57) ABSTRACT

A system and method are presented for communication routing. Communications may be routed into a queue based on criteria. A communication may be assigned to a distribution ring and a determination may be made as to whether there is an availability of resources to handle the communication. A communication may be re-routed if it cannot be handled to a new group. Re-routing may be based on criteria such as time delay, non-time based criteria such as skills, and environmental criteria, to name a few. Re-routing may continue until a communication is handled. The routing design may resemble concentric circles where the center represents the most desirable pool of handlers and each incremental ring represents the iterative expansion sets of agents.

### BACKGROUND

The present invention generally relates to telecommunications systems and methods. More particularly, the present invention pertains to the routing of communications.

### SUMMARY

A system and method are presented for communication routing. Communications may be routed into a queue based on criteria. A communication may be assigned to a distribution ring and a determination may be made as to whether there is an availability of resources to handle the communication. A communication may be re-routed if it cannot be handled to a new group. Re-routing may be based on criteria such as time delay, non-time based criteria such as skills, and environmental criteria, to name a few. Re-routing may continue until a communication is handled. The routing design may resemble concentric circles where the center represents the most desirable pool of handlers and each incremental ring represents the iterative expansion sets of agents.

In one embodiment, a method for distributing communications in an automatic communication distribution system is provided, comprising the steps of: routing a communication into a queue; assigning said communication to a distribution ring of resources; determining an availability of resources to handle said communication in said distribution ring; and re-routing said communication to a new distribution ring of resources if said distribution ring of resources cannot handle said communication.

In another embodiment, a system for distributing communications in an automatic communication distribution system is provided, comprising: means for routing a communication into a queue; means for assigning said communication to a distribution ring of resources; means for determining an availability of resources to handle said communication in said distribution ring; and means for re-routing said communication to a distribution ring of resources if said resources cannot handle said communication after said routing until said communication can be handled.

In another embodiment, a method for distributing communications in an automatic communication distribution system is provided, comprising the steps of: routing a communication into a queue; assigning said communication to a distribution ring of resources; determining an availability of resources to handle said communication; re-routing said communication to a different distribution ring of resources if said resources cannot handle said communication after said routing; and continually re-routing said communication to a different distribution ring of resources until said communication is handled.

### BRIEF DESCRIPTION OF THE DRAWINGS

FIG. 1 is a diagram illustrating an embodiment of an automatic communication distribution system.

FIG. 2 is a flowchart illustrating an embodiment of a process for communication distribution.

FIG. 3 is a diagram illustrating an embodiment of routing.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Ring expansion, in communication routing designs, may have occurred where rings associated with individual workgroups had a time threshold that would expire. At the expiration of the time threshold, the call would then be offered to a new, larger workgroup which included the original agent pool in addition to agents in the secondary ring. In another embodiment, rings were associated with individual skills, or combinations of skills. The agent pool would be increased at each threshold by changing or removing one or more skills required for a call. These embodiments caused reporting issues as the ACD processing would stop/start each time a call was passed to a new workgroup or when skills were removed from the call. These reporting issues could count a single interaction multiple times depending on the number of processing cycles.

In one embodiment, to eliminate multiple-call count reporting issues, workgroups and/or skills are not changed, added, or subtracted. Instead, a call may be delivered to a workgroup and set at an initial desired skill proficiency. The proficiency requirement may then be reduced for that skill at each time expansion threshold. A higher value may be placed on quality as opposed to speed, however, the quality requirement over speed may be eliminated over time.

In another embodiment, the availability of highly skilled agents for calls requiring their unique skillset may be preserved. Highly skilled agents may be assigned to a lower priority for all call types, except for those calls requiring their unique skills. Lesser skilled agents may be competently trained to handle a high percentage of calls without requiring excessive transfers and hold time. A delay threshold may not be included in at least one embodiment.

In one embodiment, a routing design is provided that expands the eligible call handling agent pool. The expansion of an agent pool may resemble concentric circles, where the center represents the set of the most desirable agents and each incremental ring represents an iterative expansion set of agents in a call center.

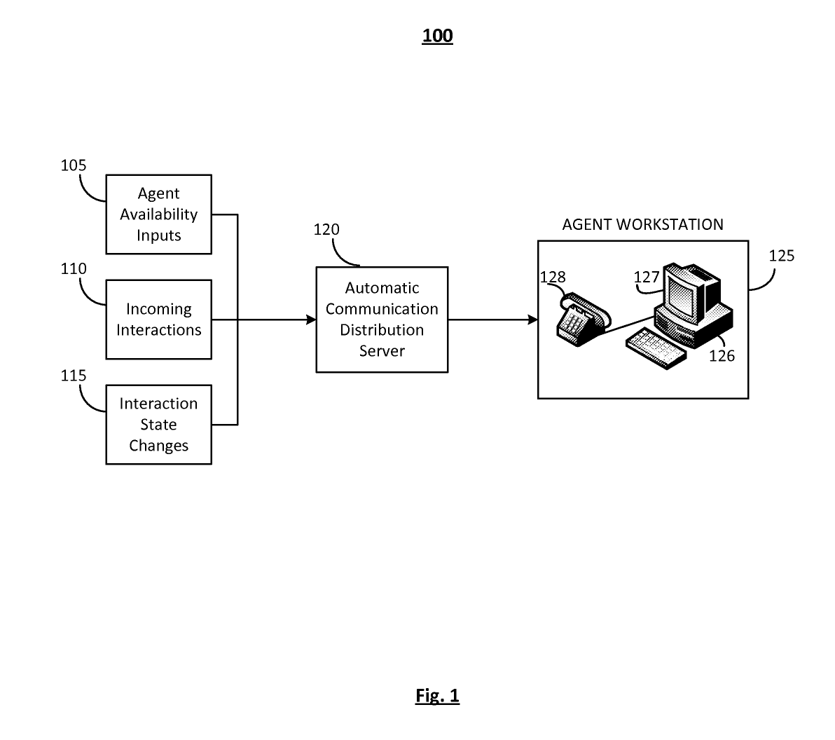

FIG. 1 is a diagram illustrating the basic components in one embodiment of an automatic communication distribution system indicated generally at 100. The basic components of an automatic communication distribution system may include elements of the system 100 such as: agent availability inputs 105, incoming interactions 110, interaction state changes 115, an automatic communication distribution server 120, and an agent workstation 125.

Agent availability inputs 105 may comprise information that is used in determining an availability of resources to handle a communication. For example, agent availability inputs 105 may comprise information about the skill levels of agents related to their ability to handle a communication. The current activity of an agent may also be taken into consideration in determining availability.

Incoming interactions 110 may comprise a communication received from a party. In at least one embodiment, a communication may be a telephone call coming into a call center from a customer or a call placed by an automated dialer and routed to an agent. A communication may comprise any sort of verbal or visual communication including, but not limited to, a video chat, a telephone call, a message chat, etc.

Interaction state changes 115 may comprise information regarding the status of the communications within a system. For example, an agent may manually take a communication instead of it being routed to them. In an instance where an incoming interaction may comprise a telephone call, a caller may hang up before their call is even handled by an agent. In these examples, a communication may change from being in a queue to no longer being available for agent handling. A communication may also be prioritized, such as, for example, a communication is in the queue and the communicant may choose an option that allows it to be moved up in the queue in the event of an emergency.

An automatic communication distribution server 120 may handle routing of communications to groups of users or resources. The routing may be based on the agent availability inputs 105, incoming interactions 110, and the interaction state changes 115, among other information such as priority and other handling information.

In one embodiment, an agent may be present at a workstation, which may include a workstation computer 126 coupled to a display 127. Workstation computers 126 may be of the same type, or a heterogeneous combination of different computing devices. Likewise, displays 127 may be of the same type or a heterogeneous combination of different visual devices. It should be understood that while two agent workstations are described in the illustrative embodiment, any number may be utilized. Contact center applications of system 100 typically include many more workstations of this type at one or more physical locations, but only one is illustrated in FIG. 1 to preserve clarity.

A digital telephone 128 may be associated with agent workstation 125. Additionally, a digital telephone 128 may be integrated into the agent computer 126 and/or implemented in software. It should be understood that a digital telephone 128, which is capable of being directly connected to a network, may be in the form of a handset, headset, or other arrangement as would occur to those skilled in the art. It shall be further understood that the connection from computer network to an agent workstation 125 can be made first to the associated workstation telephone, then from the workstation telephone to the workstation computer by way of a pass through connection on the workstation telephone. Alternatively, two connections from the network can be made, one to the workstation telephone and one to the workstation computer. Although not shown to preserve clarity, an agent workstation 125 may also include one or more operator input devices such as a keyboard, mouse, track ball, light pen, and/or microtelecommunicator, to name just a few representative examples. Additionally, besides display 127, one or more other devices may be included such as loudspeaker(s) and/or a printer.

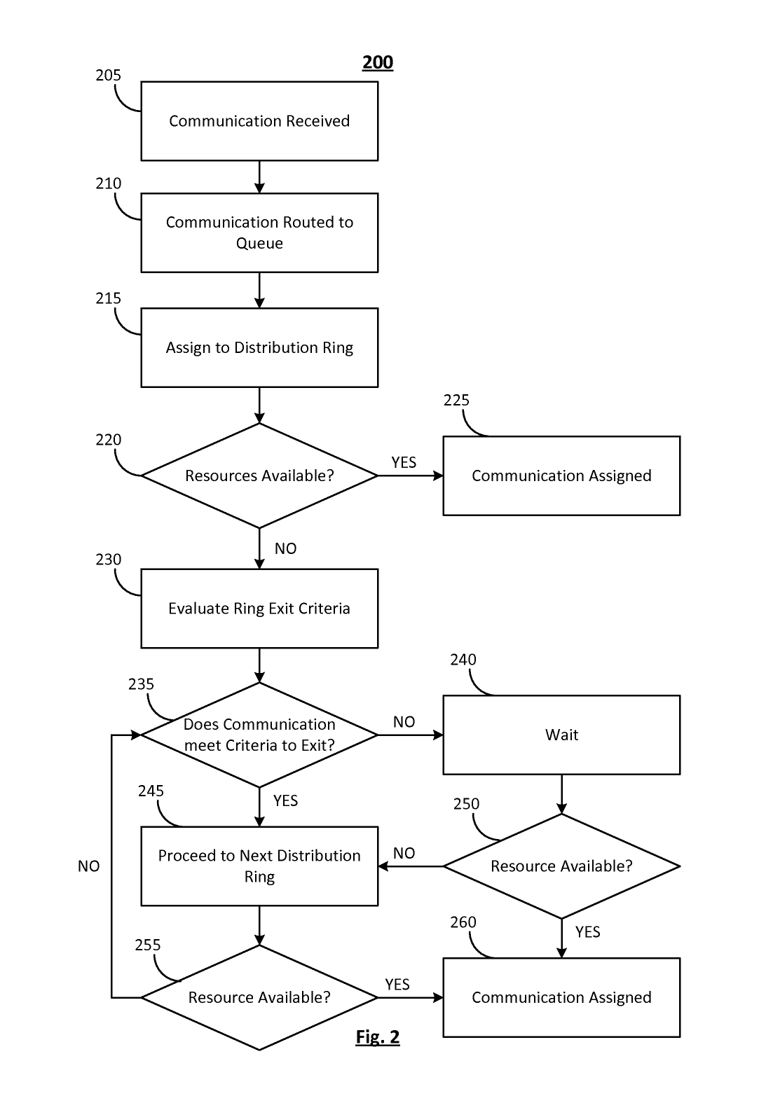

As illustrated in FIG. 2, one embodiment of a process 200 for distributing communications in an automatic communication distribution system is provided. The process 200 may be operative in the automatic communication distribution server 120 of system 100 (FIG. 1).

In operation 205, a communication is received. For example, a telephone call may be received by or connected to a contact center. Other forms of communications may include but not be limited to chats, emails, call backs, generic objects, SMS, and workflows. Control is passed to operation 210 and process 200 continues.

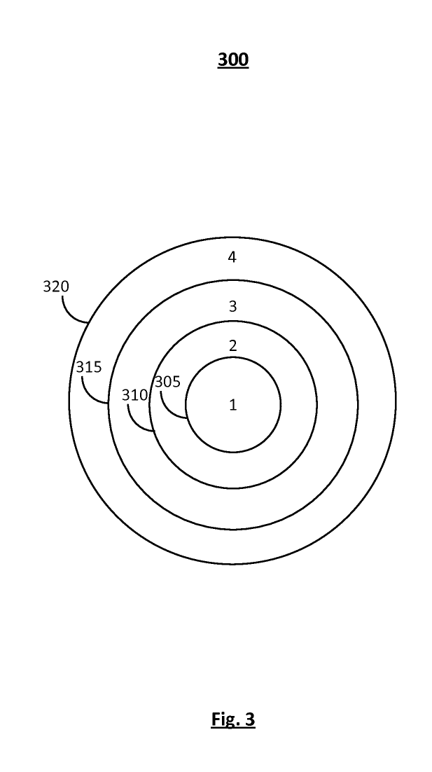

In operation 210, the communication is routed into a queue. The communication may be routed into a designated media queue for such communication types. Each type of communication may have a queue for that media type. For example, a media queue may be designated as calls, chats, emails, call backs, generic objects, SMS, or workflows. Routing may be performed according to pre-defined criteria. For example, a communication may automatically be routed after it has spent an amount of time within the queue, such as ten seconds, without being handled. Non-time limit criteria may also be employed for determining routing behavior. These criteria may be environmental and based on a service level or abandon rate. For example, a communication may be received after hours in a call center. The communication may be automatically routed to a resource to handle the communication instead of sitting with no answer. Routing may be performed according to groups of users and/or routing behavior variables for resource preferred routing. For example, skills based routing may be employed. In one embodiment, agents who speak a desired language may have communications routed to them for communicants who only speak that language. In another embodiment, routing may be performed based on product proficiency, such as whether or not the agent knows enough about a particular product in order to sufficiency handle the communication. In another embodiment, some customers may be preferred over others and thus their communication may be handled sooner than a customer not identified as preferred. Each queue may comprise one or more distribution rings of resources to handle a communication that are capable of being expanded into sequentially as is further described in FIG. 3. Control is passed to operation 215 and process 200 continues.

In operation 215 a communication is assigned to a distribution ring. For example, a communication may be assigned to a distribution ring containing the set of the most desirable agents to handle the communication. A distribution ring may contain one or more user groups assigned to a group of users. The communication may be assigned to group of users 1 (305), as exhibited and described further in FIG. 3. The assignation of a communication to a group of users may be based on criteria, such as specific skill that the agents within the group of users have. An example of a specific skill may include the ability to speak a specific language or a proficiency in a particular field of interest.

In operation 220 it is determined whether or not there is an availability of resources to handle the communication. If it is determined that there is an availability of resources to handle the communication, then control is passed to operation 225 and process 200 continues. If it is determined that there is not an availability of resources to handle the communication, then control is passed to operation 230 and process 200 continues.

The determination in operation 220 may be made based on any suitable criteria. For example, agent statuses in a call center may be set to busy or some other such status that they are unable to handle a communication. In at least one embodiment, the determining of an availability of resources is occurring continually throughout process 200. If at any point in time during the process 200 a resource becomes available, this information may be processed in order to handle a suitable communication.

In operation 225, the communication is assigned and handled and the process 200 ends.

In operation 230, criteria are evaluated. For example, when it has been determined that resources are not available to handle a communication, it will need to be sent to a distribution ring that may be able to handle said communication. The system will examine criteria that have been defined to determine where the communication can be sent. For example, a system user may have determined that for a criterion to be routed to a new group of users or a distribution ring, a time delay may be employed for the communication to exit the group of users or distribution ring. If a communication is not handled in a designated fashion after 25 seconds, for example, the proficiency requirement of a group of users to handle a communication may be broadened or changed.

In operation 235, it is determined whether or not a communication meets the criteria to be rerouted to a new group of users. If it is determined that a communication meets the criteria to be rerouted to a new group of users, control is passed to operation 245 and the process 200 continues. If it is not determined that a communication meets the criteria to be rerouted to a new group of users, control is passed to operation 240 and the process 200 continues.

The determination in operation 235 may be made based on any suitable criteria. For example, no agents may be available within the distribution ring that a communication is to be routed to. Rather than keeping the communication in the queue and waiting, the communication may be routed to another distribution ring for handling. In another example, a communication may have waited for an agent to become available for a specified period of time. If an agent has not become available in that period of time, then the communication may be routed to a new distribution ring.

In operation 240, a decision may be made to wait. For example, the system may determine to wait a specified period of time to determine whether or not a resource has become available. Control is passed to operation 250 and the process 200 continues.

In operation 245, the communication is routed to the next group of users. For example, the communication may be routed to a new distribution ring of resources that may be capable of handling the communication. Routing may be performed according to pre-defined criteria. Such criteria may include a time limit criterion. For example, a call may automatically be routed after it has spent an amount of time within the queue, such as ten seconds, without being handled. Non-time limit criteria may also be employed to determine communication routing. Further examples are presented in FIG. 3. Control is passed to operation 255 and process 200 continues.

In operation 250, it is determined whether or not a resource has become available. If it is determined that there is an availability of resources to handle the communication, then control is passed to operation 260 and process 200 continues. If it is determined that there is not an availability of resources to handle the communication, then control is passed back to operation 245 and process 200 continues.

The determination in operation 250 may be made based on any suitable criteria. For example, agent statuses in a call center may be set to busy or some other such status that they are unable to handle a communication. In at least one embodiment, the determining of an availability of resources is occurring continually throughout process 200. If at any point in time during the process 200 a resource becomes available, this information may be processed in order to handle a suitable communication.

In operation 255, it is determined whether or not a resource has become available. If it is determined that there is an availability of resources to handle the communication, then control is passed to operation 260 and process 200 continues. If it is determined that there is not an availability of resources to handle the communication, then control is passed back to operation 235 and process 200 continues.

The determination in operation 255 may be made based on any suitable criteria. For example, agent statuses in a call center may be set to busy or some other such status that they are unable to handle a communication. In at least one embodiment, the determining of an availability of resources is occurring continually throughout process 200. If at any point in time during the process 200 a resource becomes available, this information may be processed in order to handle a suitable communication.

In operation 260, the communication is assigned and handled and the process 200 ends.

FIG. 3 is a diagram illustrating an embodiment of sequential routing. Each queue may comprise one or more distribution rings of resources to handle a communication that are capable of being expanded into sequentially. The routing design for the expansion in the agent pool, in one embodiment, may resemble concentric circles where the center represents the set of most desirable agents and each incremental ring represents the iterative expansion sets of agents. One to many user groups may be assigned to each ring. Routing rules may determine how soon a communication is routed to a new group of users.

For example, when a communication is received, it may be routed to Group of Users 1 (305). The system may run a check to determine whether or not any agents are available in the group of users to handle the communication. If there is an available agent, then the communication will alert that agent. If there are no available agents, then the call is immediately overflowed into the next designated group of users, such as Group of Users 2 (310). The system may again run a check to determine whether or not any agents are available in the group of users to handle the communication. If there is an available agent, then the communication will alert that agent and the agent may handle the communication. If there are no available agents, then the call is again overflowed into the next designated group of users, such as Group of Users 3 (315) and Group of Users 4 (320). This process may continue to repeat as necessary until a communication is handled based on the number of designated groups of users. If a communication reaches a point where it has not been handled after passing through all of the groups of users, then all agents in all groups of users may be designated.

Criteria may be examined in order to determine where a communication is routed. Criteria may be assigned to distribution rings. Such criteria may be user designated. For example, a user may designate criteria as skills or skill categories. A handler may require a specific set of skills in order to be associated with a distribution ring, such as the ability to speak a specific language.

In one embodiment, for example, multiple-call count reporting issues may be eliminated. This form of routing communications does not change, add, or subtract groups of users and/or skills. Instead, it delivers a communication to a group of users and sets the communication at an initial desired skill proficiency. The proficiency requirement for that skill may be reduced at each expansion threshold. For example, a call may enter the Help Desk group of users with a Microsoft Skill proficiency of 100 and waits if not immediately answered by the Engineers with Microsoft Skills. If the call is not answered in a designated fashion, such as after 25 seconds, the Microsoft proficiency requirement may be lowered to 90, or some other designated value. If the call is not able to be handled after an additional amount of time, then the proficiency requirement may again be lowered to a level of 50, for example, such that the call is routed to all customer service agents. By assigning Microsoft-only engineers proficiency levels of 100, all other engineers proficiency levels between 90 and 99, and all other customer service agents levels between 50 and 89; this routing will first offer this call type to Microsoft skilled engineers. If no Microsoft skilled engineers become available within 25 seconds, the target would “expand” to include Microsoft engineers and all engineers. Finally, if the call is not answered in an additional 120 seconds, the call target would be expanded to include all customer service agents.

Time delay does not have to be employed for a call to be re-routed into another group of users. Other criteria may be used. For example, in an embodiment where time delay is not employed, skills based routing may be employed. Highly skilled agents may be assigned a lower priority for all call types except for those calls requiring their unique skills. Lesser skilled agents may be competently trained to handle a higher percentage of the calls without requiring excessive transfers and hold time, thus preserving availability of highly skilled agents for communications requiring their unique skillsets. Examples of skill may include languages spoken to accommodate the different languages in which communications may be received in. Communications may be routed depending on the level of a language spoken. Routing may also be based on group of users, such as department based or by collections of people in geographic locations. For example, calls answered in an Ohio call center may be sent on to a call center in Canada if no one is available.

In another embodiment, if a resource becomes available, the system may search for the best matching resource to an interaction waiting within the queue. This does not necessarily need to be the interaction that has been longest in the queue. Other factors may be involved such as the skills required by an interaction and those of the resource.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for distributing communications in an automatic communication distribution system comprising the steps of:
a. routing a communication into a queue;
b. assigning said communication to a distribution ring of resources;
c. determining an availability of resources to handle said communication in said distribution ring, wherein said determining examines whether criteria have been met by the communication to exit the distribution ring; and
d. re-routing said communication to a new distribution ring of resources if said distribution ring of resources cannot handle said communication.

2. The method of claim 1, wherein steps c) and d) are repeated until a communication is handled.

3. The method of claim 1, wherein the step of routing and the step of re-routing are performed according to pre-defined criteria.

4. The method of claim 1, wherein the step of routing and the step of re-routing are performed according to a time limit criteria.

5. The method of claim 1, wherein the step of routing and the step of re-routing are performed according to a non-time limit criteria.

6. The non-time limit criteria of claim 5, wherein said non-time limit criteria is environmental.

7. The environmental criteria of claim 6, wherein said environmental criteria is based on at least one of service level and abandon rate.

8. The non-time limit criteria of claim 5, wherein said non-time limit criteria further comprises a communication received at a specified time of day which is automatically routed to a new distribution ring.

9. The communication of claim 1, wherein said communication comprises a telephone call.

10. The queue of claim 1, wherein said queue comprises one or more levels of resources to handle a communication that are capable of being expanding into sequentially.

11. The queue of claim 1, wherein said queue is designated according to a media type.

12. The queue of claim 1, wherein said queue is designated as at least one of: a call, a chat, an email, a call back, a generic object, an SMS, and a workflow.

13. The method of claim 1, wherein step (b) further comprises the step of examining a criteria assigned to a distribution ring.

14. The criteria of claim 13, wherein said criteria are designated by a user as skills.

15. The criteria of claim 13, wherein said criteria are designated by a user as skill categories.

16. The method of claim 1, wherein the step of routing and the step of re-routing are performed according to at least one of: groups of users and routing behavior variables for resource preferred routing.

17. The method of claim 2, wherein routing to said new distribution rings occurs sequentially.

18. A system for distributing communications in an automatic communication distribution system comprising:
a. means for routing a communication into a queue;
b. means for assigning said communication to a distribution ring of resources;
c. means for determining an availability of resources to handle said communication in said distribution ring, wherein said determining examines whether criteria have been met by the communication to exit the distribution ring; and
d. means for re-routing said communication to a distribution ring of resources if said resources cannot handle said communication after said routing until said communication can be handled.

19. The queue of claim 18, wherein said queue comprises media queues wherein said media queues are referred to as one or more of: media types and a name of a distribution queue.

20. The system of claim 18, wherein said system further comprises a means for a user to switch between configurations of different media types.

21. A method for distributing communications in an automatic communication distribution system comprising the steps of:
a. routing a communication into a queue;
b. assigning said communication to a distribution ring of resources;
c. determining an availability of resources to handle said communication, wherein said determining examines whether criteria have been met by the communication to exit the distribution ring;
d. re-routing said communication to a different distribution ring of resources if said resources cannot handle said communication after said routing; and
e. continually re-routing said communication to a different distribution ring of resources until said communication is handled.

22. The method of claim 21, wherein the steps of routing and re-routing are performed according to pre-defined criteria.

23. The method of claim 21, wherein the steps of routing and re-routing are performed according to a time limit criteria.

24. The method of claim 21, wherein said routing and re-routing is performed according to a non-time limit criteria.

25. The non-time limit criteria of claim 24, wherein said non-time limit criteria is environmental.

26. The environmental criteria of claim 25, wherein said environmental criteria is based on at least one of service level and abandon rate.

27. The non-time limit criteria of claim 24, wherein said non-time limit criteria further comprises a communication received at a specified time of day which is automatically routed to a new distribution ring.

28. The method of claim 21, wherein the routing to said different distribution ring occurs sequentially.

29. The communication of claim 21, wherein said communication comprises a telephone call.

30. The queue of claim 21, wherein said queue comprises one or more levels of resources to handle a communication that are capable of being expanding into sequentially.

31. The queue of claim 21, wherein said queue is designated according to a media type.

32. The queue of claim 21, wherein said queue is designated as at least one of: a call, a chat, an email, a call back, a generic object, an SMS, and a workflow.

33. The method of claim 21, wherein step (b) further comprises the step of examining a criteria assigned to a distribution ring.

34. The criteria of claim 33, wherein said criteria are designated by a user as skills.

35. The criteria of claim 33, wherein said criteria are designated by a user as skill categories.

36. The method of claim 21, wherein the steps of routing and re-routing are performed according to at least one of: groups of users and routing behavior variables for resource preferred routing.
